(19) United States
(12) Patent Application Publication
(10) Pub. No.: US 2025/0159451 A1
(43) Pub. Date: May 15, 2025

(54) SYSTEM AND METHOD FOR A CONNECTOR APPLICATION TO CAUSE AN ACTION TO BE EXECUTED BY A PUBLIC SAFETY DEVICE

(71) Applicant: MOTOROLA SOLUTIONS, INC., CHICAGO, IL (US)

(72) Inventors: NICOLE D. BERRIZ, DAVIE, FL (US); STEPHEN C. GLASS, PLANTATION, FL (US); THOMAS B. BOHN, MCHENRY, IL (US); SEAN REGAN, DELRAY BEACH, FL (US); MARYAM ENEIM, SILVER SPRING, MD (US)

(21) Appl. No.: 18/508,374

(22) Filed: Nov. 14, 2023

(51) Int. Cl. H04W 4/90; G08B 25/00

(52) U.S. Cl. CPC H04W 4/90; G08B 25/006

(57) ABSTRACT

A connector application is provided. A trigger is received from a workflow server. The trigger includes an action ID. A public safety device is identified from a plurality of public safety devices based on agency private information. The identified public safety device is to perform an action in response to the trigger. No agency private information is shared with the workflow server. An indication is sent to the identified public safety device to execute the action.

### BACKGROUND OF THE INVENTION

Managing multiple devices within a security ecosystem can be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system may have to be configured to provide the notifications to the radios and the video security system may have to be configured to provide the notifications to the radios. Thus, both the access control system and the video security system may need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem may be needed in order to properly configure workflows within the ecosystem.

In order to reduce the burden on administrators and enhance their efficiency, a need exists for a user-friendly interface tool that gives administrators the ability to configure and automate workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a security ecosystem capable of configuring and automating workflows.

FIG. 2 illustrates a security ecosystem capable of configuring and automating workflows.

FIG. 3 illustrates a security ecosystem capable of configuring and automating workflows.

FIG. 5 illustrates a security ecosystem capable of configuring and automating workflows.

FIG. 4 illustrates a security ecosystem capable of configuring and automating workflows.

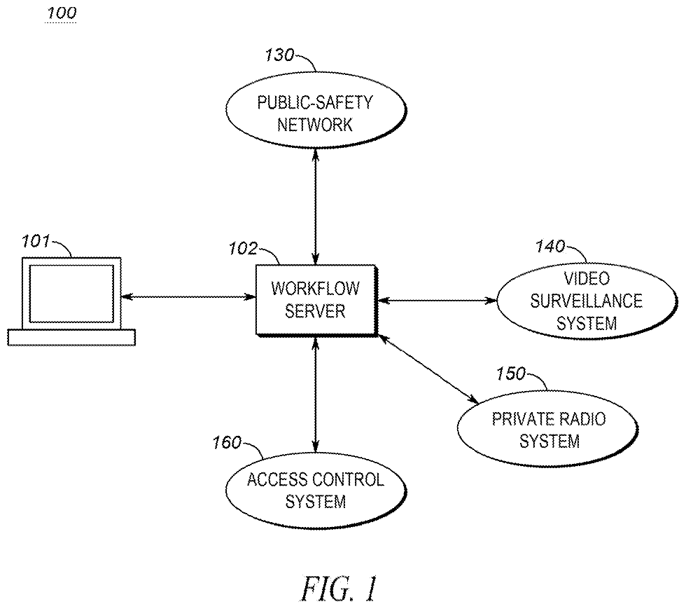

FIG. 6 is a block diagram of a workflow server of FIG. 1.

FIG. 7 is a block diagram of a workstation of FIG. 1 utilized to create a workflow.

FIG. 8 illustrates the creation of a workflow.

FIG. 9 illustrates the creation of a workflow.

FIG. 10 illustrates the creation of a workflow.

FIG. 11 is an example of a communications system that may implement the connector application to cause an action to be executed by a public safety device techniques described herein.

FIG. 12 illustrates the creation of a workflow using actions provided by a connector application according to the techniques described herein.

FIG. 13 is an example flow chart describing an implementation of a connector application according to techniques described herein.

FIG. 14 is an example of a flowchart for supporting multiple public safety networks with a one connector application.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a system, method, and apparatus for implementing workflows across multiple differing systems and devices is provided herein. A workflow server may be used to allow a user to create workflows from multiple disparate systems. For example, an enterprise may have video surveillance systems, private radio systems, and access control systems. Workflows may be generated such that when an event (e.g. a trigger) in one of those systems is detected, an action may be taken by another system. For example, if the video surveillance system detects that a person is loitering by a door, the action performed may be to dispatch a security guard to the loitering location.

It should be noted that the previously described systems are generally all under the control of the enterprise. As such, sharing of information between the various systems and the workflow server is not an issue, as all of those systems are under common control/ownership.

The workflow server may also be connected to other systems that are not under the control of the enterprise. For example, the workflow server may be connected to a public safety network (e.g. police, fire, emergency medical services, etc.). A trigger event, such as loitering may occur. The action performed may be to cause a police officer to be dispatched to the scene of loitering, just as was described above with respect to a security guard being dispatched.

However, a problem arises in that the public safety network is not under the control of the enterprise. The public safety network may not wish to share information about which personnel are currently available to respond. The public safety network may also wish to prioritize its response based on other activity currently in progress. For example, in the loitering example, if the public safety agency is currently engaged in other higher priority tasks, it may not wish to respond to a low level loitering call. In short, the public safety agency may not wish to share agency private data with the organization.

The techniques described herein resolve this problem, and others, by providing a connector application disposed between a workflow server executing workflows and a public safety network. The connector application may determine one or more actions that the public safety network may be capable of performing. The actions may be based on public safety agency private information. For each action, the connector application may establish an action ID.

The connector application may provide actions to the workflow server that can be executed. The actions may include action IDs. The operator of the workflow server may use these actions in a workflow, just as if they were under the control of the enterprise. What should be understood is that the actions associated with the action ID do not cause any particular action to be taken within the public safety network. Instead, when a trigger requires the action to be executed, the action is sent to the connector application. The connector application, upon receiving an action including an action ID may then interface with the public safety network to determine exactly what actions will be taken within the public safety network. The actions taken may be dynamic based on the current state of the public safety network. No agency private information is ever sent to the workflow server.

The connector application, working in conjunction with the public safety network may then cause the action to be executed. As the connector application is provided by the public safety network, the connector application is trusted to access agency private information.

For example, assume that the connector application provides a “Notify Public Safety Loitering Detected” action. The connector application may provide this action, and corresponding action ID, to the workflow server for use in creating workflows. The workflow server may be used to create a workflow for when loitering is detected. For example, when there is a loitering trigger, the action with the action ID associated with notifying public safety that loitering has been detected is sent by the workflow server to the connector application. What should be noted is that the workflow server is not directly communicating with, nor causing any actions to occur, within the public safety network. In fact, the workflow server may not be made aware of the actions taken by the public safety network.

Upon receipt of the action ID by the connector application, the connector application, working in conjunction with the public safety network may determine what actions are to be taken. The action to be taken may be dependent on the current dynamic state of the public safety network. The current state of the public safety network may be based on agency private information that would be undesirable to share with the workflow server.

For example, when the loitering detected action ID is initiated, the connector application may interface with the public safety network to identify the closest officer (e.g. via geolocation of the officer's radio) to the location where loitering was detected. A notification could then be sent to that officer only to investigate. As should be clear, the workflow server need not be aware of any of the location, or any other information, such as the officer's identity and/or device identification (e.g. agency private information) in order to have the closest officer respond.

The actions performed are dynamic as well. For example, in the loitering example described, the public safety network may currently have no resources available to investigate. As such, there may be no immediate action, and the action taken will be to investigate once resources are available. Again, the information that no resources are currently available is not shared with the workflow server.

A communication system is provided. The communication system comprises a workflow server operating within a commercial enterprise. The communication system further comprises a private radio system comprising at least one radio operatively coupled through a wireless connection to the workflow server, the workflow server executing workflows to manage the at least one radio in response to predetermined triggers received by the workflow server. The communication system further comprises a public safety radio operatively coupled through a wireless connection to a public safety Radio Access Network operating within a Public Safety Core Network. The communication system further comprises the workflow server in response to receiving the predetermined trigger, being configured to send a notification to a connector application operatively coupled to the Public Safety Core Network to execute a public safety action, the notification containing a public safety action ID.

In one aspect of the communication system, the connector application is configured to connect to the public safety core network and create the public safety action ID based on agency specific information, and add the created public safety action ID to the workflow server. In one aspect of the communication system, the connector application is configured to receive the notification and execute the public safety action based on the public safety action ID, independently of the workflow server. In one aspect of the communication system, the workflow server executes the workflow by sending a list of action IDs from the workflow server to the connector application, wherein control of the execution resides in the connector application.

In one aspect of the communication system, the public safety radio is one of a plurality of public safety radios operating in accordance with agency specific functions of a Public Safety agency. In one aspect of the communication system, an agency pre-provisions the public safety radio to accept workflow management from the connector application based on workflows defined in the workflow server. In one aspect of the communication system, agency specific information associated with the connector application is isolated from the workflow server. In one aspect of the communication system, the trigger is generated by at least one of a security camera, a fire detector, and an automated license plate reader.

A method performed by a connector application is provided. The method comprises receiving, from a workflow server, a trigger, the trigger including an action ID. The method further comprises identifying a public safety device from a plurality of public safety devices, based on agency private information, to perform an action in response to the trigger, wherein no agency private information is shared with the workflow server. The method further comprises sending an indication to the identified public safety device to execute the action.

In one aspect, the method further comprises creating an action ID and sending the action ID to the workflow server, wherein the action ID is incorporated into workflows generated by the workflow server, wherein no agency private information is included in the workflows. In one aspect, the method further comprises receiving, from the workflow server, additional information associated with the trigger, wherein the action to be performed by the public safety device is determined based on the action ID and the additional information.

In one aspect of the method, agency private information includes public safety device geographic location. In one aspect of the method, agency private information includes public safety device roll assignment information. In one aspect of the method, agency private information includes public safety device availability status. In one aspect, the method further comprises querying a plurality of public safety networks to identify if integration with the connector application is supported and sending action IDs to those public safety networks that support the integration. In one aspect of the method the public safety device is a public safety radio.

A non-transitory processor readable medium containing a set of instructions to implement a connector application thereon is provided. The instructions that when executed by a processor cause the processor to receive, from a workflow server, a trigger, the trigger including an action ID. The instructions on the medium further cause the processor to identify a public safety device from a plurality of public safety devices, based on agency private information, to perform an action in response to the trigger, wherein no agency private information is shared with the workflow server. The instructions on the medium further cause the processor to send an indication to the identified public safety device to execute the action.

In one aspect, the medium further comprises instructions that cause the processor to create an action ID and send the action ID to the workflow server, wherein the action ID is incorporated into workflows generated by the workflow server, wherein no agency private information is included in the workflows. In one aspect, the medium further comprises instructions that cause the processor to receive, from the workflow server, additional information associated with the trigger, wherein the action to be performed by the public safety device is determined based on the action ID and the additional information. In one aspect, the medium further comprises instructions that cause the processor to query a plurality of public safety networks to identify if integration with the connector application is supported and send action IDs to those public safety networks that support the integration.

Each of the above-mentioned aspects will be discussed in more detail below, starting with example system and device architectures of the system in which the embodiments may be practiced, followed by an illustration of processing blocks for achieving a system and method for a connector application to cause an action to be executed by a public safety device.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

Turning now to the drawings, wherein like numerals designate like components, FIG. 1 illustrates a security ecosystem 100 capable of configuring and automating workflows across multiple systems. The security ecosystem 100 is interchangeably referred to hereafter as the system 100.

The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

As shown, the security ecosystem 100 comprises a public-safety network 130, a video surveillance system 140, a private the private radio system 150, and an access control system 160. The workflow server 102 is coupled to each system 130, 140, 150, and 160. The workstation 101 is shown coupled to the workflow server 102, and is utilized to configure the workflow server 102 with workflows, for example as created by a user. It should be noted that although the components in FIG. 1 are shown geographically separated, these components can exist within a same geographic area, such as, but not limited to a school, a hospital, an airport, a sporting event, a stadium, a factory, a warehouse and/or any other suitable location and/or building and the like. It should also be noted that although only networks and systems 130, 140, 150, 160 are shown in FIG. 1, many more networks and/or systems may be included in the security ecosystem 100 and/or any suitable number of networks and/or systems may be included in the security ecosystem 100.

The workstation 101 may comprise a computer configured to execute Motorola Solution's Orchestrate™ and Ally™ dispatch and incident management software. As will be discussed in more detail below, the workstation 101 is configured to present a user with a plurality of triggers capable of being detected by the network and systems 130, 140, 150, 160 as well as present the user with a plurality of actions capable of being executed by the network and systems 130, 140, 150, 160. The user will be able to create workflows and upload these workflows to the workflow server 102 based on the presented triggers and actions.

The workflow server 102 may comprise a server running Motorola Solution's Command Central™ software suite comprising the Orchestrate™ platform. The workflow server 102 is configured to receive workflows created by the workstation 101 and implement the workflows. Particularly, the workflows are implemented by analyzing events detected by the network and systems 130, 140, 150, 160 and executing appropriate triggers. In a particular example, a user may create a workflow on the workstation 101 that has a trigger comprising the video surveillance system 140 detecting a loitering event, and has an action comprising notifying radios within the public-safety network 130. When this workflow is uploaded to the workflow server 102, the workflow server 102 will notify the radios of any loitering event detected by the video surveillance system 140.

The public-safety network 130 is configured to detect various triggers and report the detected triggers to the workflow server 102. The public-safety network 130 is also configured to receive action commands from the workflow server 102 and execute the actions. In some examples, the public-safety network 130 comprises includes typical radio-access network (RAN) elements such as base stations, base station controllers (BSCs), routers, switches, and the like, arranged, connected, and programmed to provide wireless service to user equipment, report detected events, and execute actions received from the workflow server 102.

The video surveillance system 140 is configured to detect various triggers and report the detected triggers to the workflow server 102. The video surveillance system 140 is also configured to receive action commands from the workflow server 102 and execute the actions. In one example, the video surveillance system 140 comprises a plurality of video cameras that may be configured to automatically change their field of views over time. The video surveillance system 140 is configured with a recognition engine/video analysis engine (VAE) that comprises a software engine that analyzes any video captured by the cameras. Using the VAE, the video surveillance system 140 is capable of “watching” video to detect any triggers and report the detected triggers to the workflow server 102. These triggers may include, but are not limited to, appearance searches and unusual Activity Detection (e.g., loitering). In a similar manner, the video surveillance system 140 is configured to execute action commands received from the workflow server 102. In some examples, the video surveillance system 140 comprises an Avigilon™ Control Center (ACC) server having Motorola Solution's Access Control Management (ACM)™ software suite.

The private radio system 150 may comprise a private enterprise radio system that is configured to detect various triggers and report the detected triggers to the workflow server 102. The private radio system 150 is also configured to receive action commands from the workflow server 102 and execute the actions. In some examples, the private radio system 150 comprises a MOTOTRBO™ communication system having radio devices that operate in the Citizens Broadband Radio Service (CBRS) spectrum and combines broadband data with voice communications.

The access control system 160 comprises an Internet-of-Things (IoT) network which may serve to connect every-day devices to the Internet. Devices such as cars, kitchen appliances, medical devices, sensors, doors, windows, HVAC (heating, ventilation, and air conditioning) systems, drones, . . . , etc. can all be connected through the IoT network of the access control system 160. Indeed, any suitable device that can be powered may be connected to the internet to control its functionality. The access control system 160 generally allows objects to be sensed or controlled remotely across existing network infrastructure. For example, the access control system 160 may be configured to provide access control to various doors and windows. In particular, the access control system 160 is configured to detect various triggers (e.g., door opened/closed) and report the detected triggers to the workflow server 102. The access control system 160 is also configured to receive action commands from the workflow server 102 and execute the action received from the workflow server 102. The action commands may take the form of instructions to lock, open, and/or close a door or window.

As is evident, the security ecosystem 100 allows an administrator using the workstation 101 to create rule-based, automated workflows between technologies to enhance efficiency, and improve response times, effectiveness, and overall safety. The above the security ecosystem 100 has the capability to detect triggers across a number of devices within network and systems 130, 140, 150, 160 quickly take actions by automatically executing the proper procedure (i.e., executing the appropriate action once a trigger is detected).

The network and systems 130, 140, 150, 160 are next described in further detail.

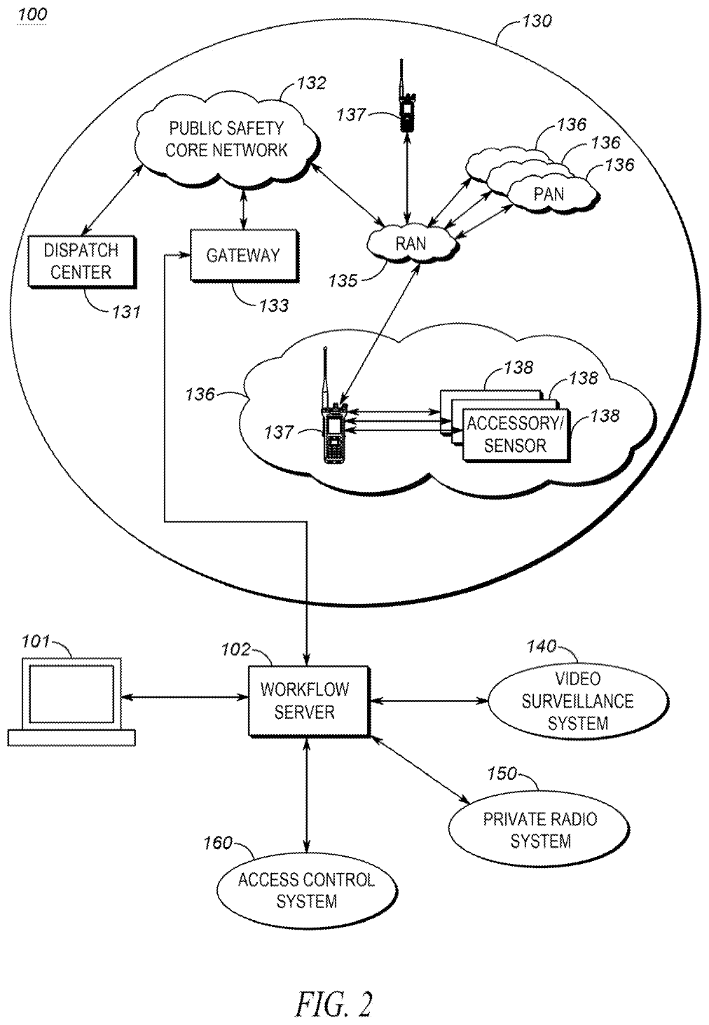

FIG. 2 illustrates a security ecosystem capable of configuring and automating workflows. In particular, FIG. 2 shows the security ecosystem 100 with an expanded view of the public-safety network 130. As shown, the public-safety network 130 comprises a dispatch center 131, a public-safety core network 132, a gateway 133, a radio access network (RAN) 135, a plurality of personal-area networks (PANs) 136, and at least radio 137, such as a public-safety radio and the like. As shown, each PAN 136 comprises a radio 137 acting as a hub to smart devices/accessories/sensor 138 (interchangeably referred to hereafter as the sensors and/or a sensor 138).

The gateway 133 may comprise an Avigilon™ Control Center running Avigilon's Access Control Management software. The gateway 133 is configured to run any suitable Application Program Interface (API) to provide communications between the public-safety core network 132 and the workflow server 102.

A public safety officer (not shown in FIG. 2) may be equipped with sensors 138 that determine various physical and environmental conditions surrounding the public-safety officer. These conditions may be reported back to, for example, the dispatch center 131 or the workflow server 102 so an appropriate action may be taken. For example, police officers may have a sensor 138 (e.g. in the form of a gun-draw sensor) that determines when a gun is drawn. Upon detecting that an officer has drawn their gun, a notification may be sent back to the dispatch operator and/or the workflow server 102 so that, for example, other officers in the area may be notified of the situation.

It is envisioned that the public-safety officer may have an array of these sensors 138 available to the officer at the beginning of a shift. The officer may select and pull sensors 138 off a shelf, and form a personal-area network (PAN) 136 with the devices that may accompany the officer on their shift. For example, the officer may pull a gun-draw sensor, a body-worn camera, a wireless microphone, a smart watch, a police radio, smart handcuffs, a man-down sensor, a bio-sensor, and the like. All sensors 138 pulled by the officer may be configured to form a PAN 136 by associating (pairing) with each other and communicating wirelessly among the devices. At least one device may be configured with a digital assistant. In some examples, a PAN 136 comprises more than two sensors 138, so that many sensors 138 may be connected via a PAN 136 simultaneously.

A method called bonding may be used for recognizing specific sensors 138 and thus enabling control over which accessories are allowed to connect to each other when forming a PAN 136. Once bonded, accessories then can establish a connection without user intervention. A bond may be created through a process called “pairing”. The pairing process may be triggered by a specific request by the user to create a bond from a user via a user interface on the accessories. Thus, as shown, public-safety network 130 incorporates PANs 136 created as described above. In some examples, radios 137 and sensors 138 form a PAN 136, with communication links between sensors 138 and radios 137 taking place utilizing a short-range communication system protocol such as a Bluetooth communication system protocol. In this particular example, a PAN 136 may be associated with a single officer. Thus, FIG. 2 illustrates multiple PANs 136 associated with multiple officers (not shown).

The RAN 135 may include various RAN elements such as base stations, base station controllers (BSCs), routers, switches, and the like, arranged, connected, and programmed to provide wireless service to user equipment (e.g., the radios 137, and the like) in a manner known to those of skill in the relevant art. The RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other examples, the RAN 135 may implement a Long Term Evolution (LTE), LTE-Advance, or 5G protocol including multimedia broadcast multicast services (MBMS) or single site point-to-multipoint (SC-PTM) (including, but not limited to open mobile alliance (OMA) push to talk (PTT) over cellular (OMA-PoC)), a voice over IP (VOIP), an LTE Direct or LTE Device to Device, or a PTT over IP (PoIP) application may be implemented. In still further examples, the RAN 135 may implement a Wi-Fi protocol for example operating in accordance with an IEEE 802.11 standard (e.g., 802.11a, 802.11b, 802.11g) or a WiMAX protocol for example operating in accordance with an IEEE 802.16 standard.

The public-safety core network 132 may include one or more packet-switched networks and/or one or more circuit-switched networks, and in general provides one or more public-safety agencies with any suitable computing and communication needs, transmitting any suitable public-safety-related data and communications.

For narrowband LMR wireless systems, the public-safety core network 132 may operate in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (such as at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) c based on user input, and the switching and/or radio network may track group membership and route new group calls according to the current group membership.

The radios 137 generally serve as PAN main devices, and may be any suitable computing and communication device configured to engage in wireless communication with the RAN 135 over the air interface as is known to those in the relevant art. Moreover, one or more radios 137 are further configured to engage in wired and/or wireless communication with one or more local sensor 138 via a local communication link. The radios 137 may be configured to determine when to forward information received from PA sensors 138 to, for example, a dispatch center or the workflow server 102.

Some examples of sensors 138 follow:

In some examples, a sensor 138 may comprise a sensor-enabled holster that maintains and/or provides state information regarding a weapon or other item normally disposed within the user's sensor-enabled holster. The sensor-enabled holster may detect a change in state (presence to absence) and/or an action (removal) relative to the weapon normally disposed within the sensor-enabled holster. The detected change in state and/or action may be reported to a radio 137 via its short-range transceiver, which may forward the state change to the dispatch center 131 or the workflow server 102. In some examples, the sensor-enabled holster may also detect whether the first responder's hand is resting on the weapon even if it has not yet been removed from the holster and provide such information to portable radio 137.

In some examples, a sensor 138 may comprise a biometric sensor (e.g., a biometric wristband) for tracking an activity of the user or a health status of a user, and may include one or more movement sensors (such as an accelerometer, magnetometer, and/or gyroscope) that may periodically or intermittently provide to a radio 137 indications of orientation, direction, steps, acceleration, and/or speed, and indications of health such as one or more of a captured heart rate, a captured breathing rate, and a captured body temperature of the user, for example accompanying other information. This information may be reported to a radio 137 which may forward the information to the dispatch center 131 and/or the workflow server 102.

In some examples, a sensor 138 may comprise an accelerometer to measure acceleration. Single and multi-axis models are available to detect magnitude and direction of the acceleration as a vector quantity, and may be used to sense orientation, acceleration, vibration shock, and falling. The accelerometer may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing. This information may be reported to a radio 137 which may forward the information to dispatch center 131 and/or the workflow server 102.

In some examples, a sensor 138 may comprise a heart rate sensor that uses electrical contacts with the skin to monitor an electrocardiography (EKG) signal of its wearer, or may use infrared light and imaging device to optically detect a pulse rate of its wearer, among other possibilities. This information may be reported to a radio 137 which may forward the information to the dispatch center 131 and/or the workflow server 102.

In some examples, a sensor 138 may comprise a breathing rate sensor 138 to monitor breathing rate. The breathing rate sensor may include use of a differential capacitive circuits or capacitive transducers to measure chest displacement and thus breathing rates. In other examples, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to a radio 137 which may forward the information to the dispatch center 131 and/or the workflow server 102.

The dispatch center 131 may comprise, and/or may be part of, a computer-aided-dispatch center (sometimes referred to as an emergency-call center or public-safety answering point), that may be manned by an operator providing any suitable dispatch operations. For example, the dispatch center 131 may comprise a graphical user interface that provides the dispatch operator any suitable information about public-safety officers. As discussed above, some of this information originates from sensors 138 providing information to radios 137, which forwards the information to the RAN 135 and ultimately to the dispatch center 131.

In a similar manner, information about public-safety officers may be provided to the workflow server 102. This information may originate from the sensors 138 providing information to the radios 137, which forwards the information to the RAN 135 and ultimately to the workflow server 102 via the public safety core network 132 and the gateway 133. For example, a sensor 138 comprising a gun-draw sensor may send an indication to the workflow server 102 that a gun has been drawn. This may serve as a “trigger” for the workflow server 102 to initiate a particular “action”, for example, notifying surrounding officers (for example on a particular talkgroup) by having their radios 137 provide an alarm indicating the triggering event. Thus, the workflow server 102 may provide instructions to any sensor 138 or radio 137 by sending an “action” to a sensor 138 in response to a trigger being received.

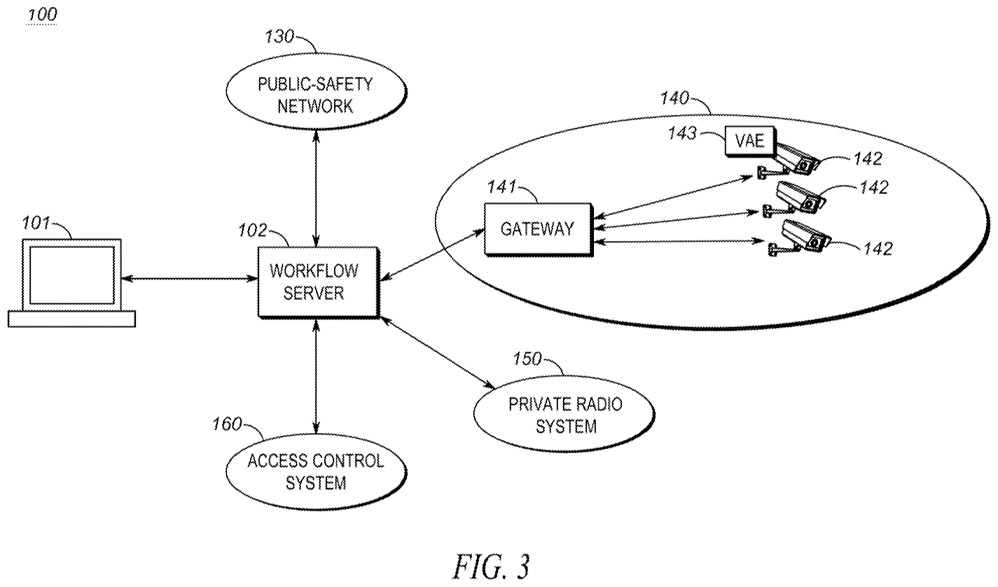

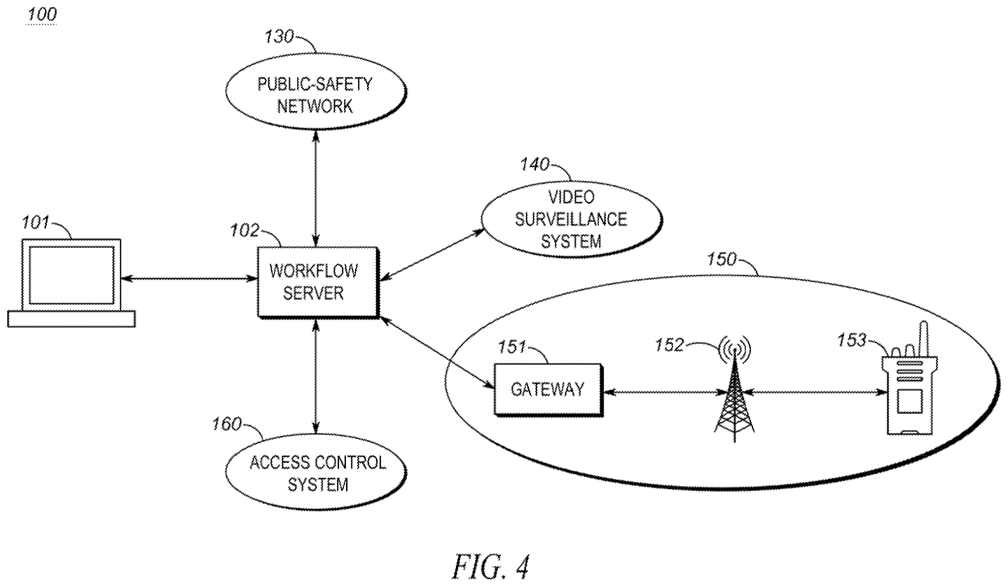

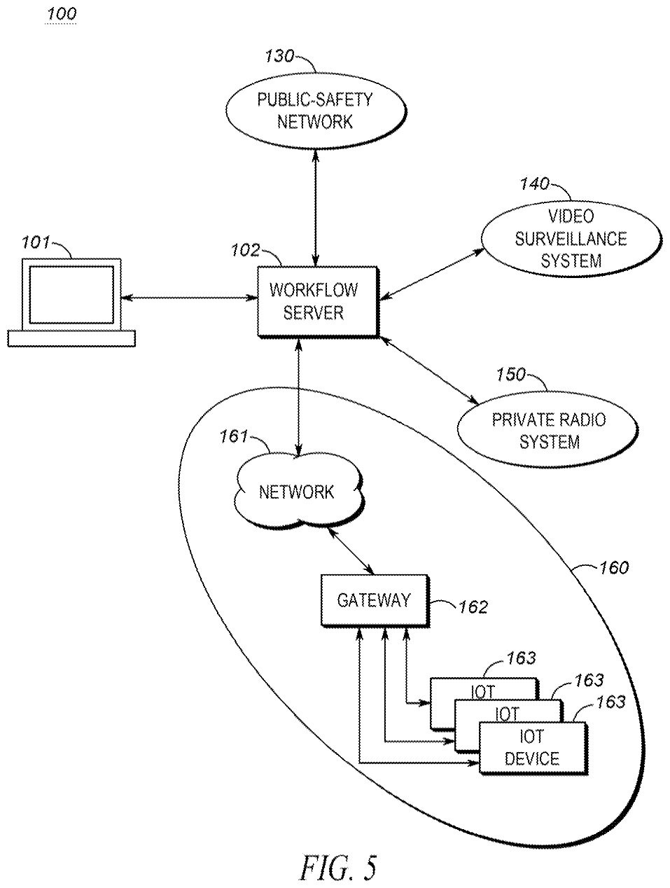

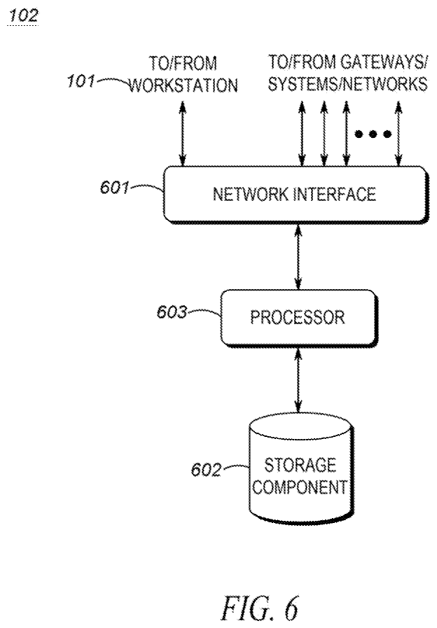

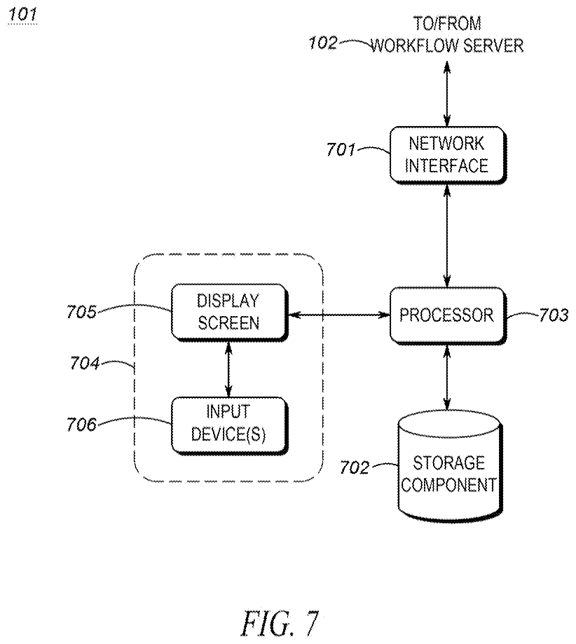

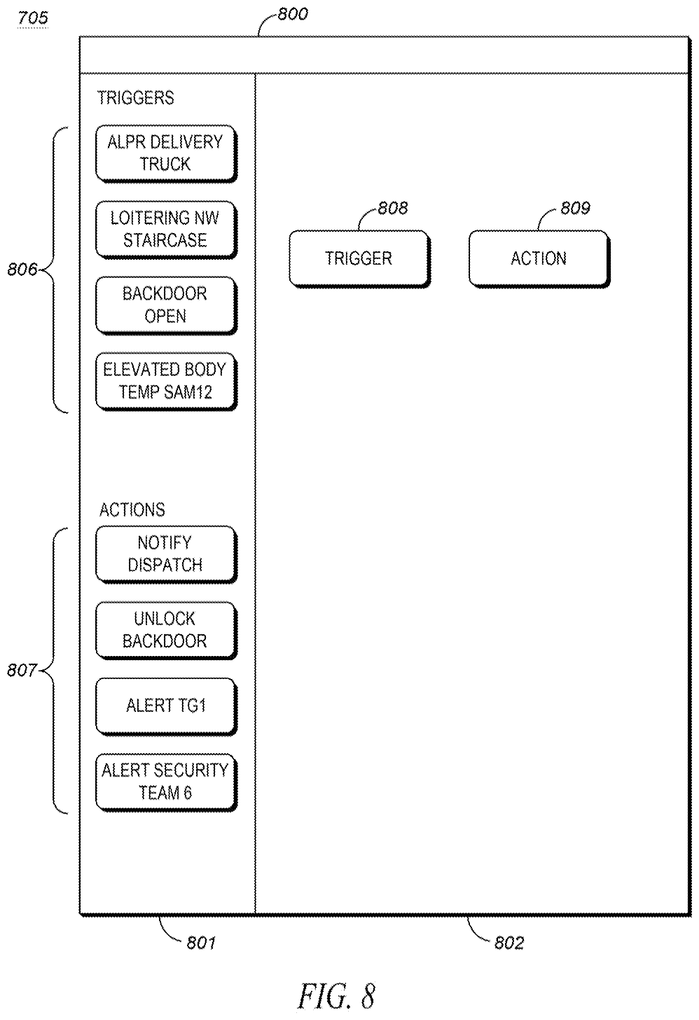

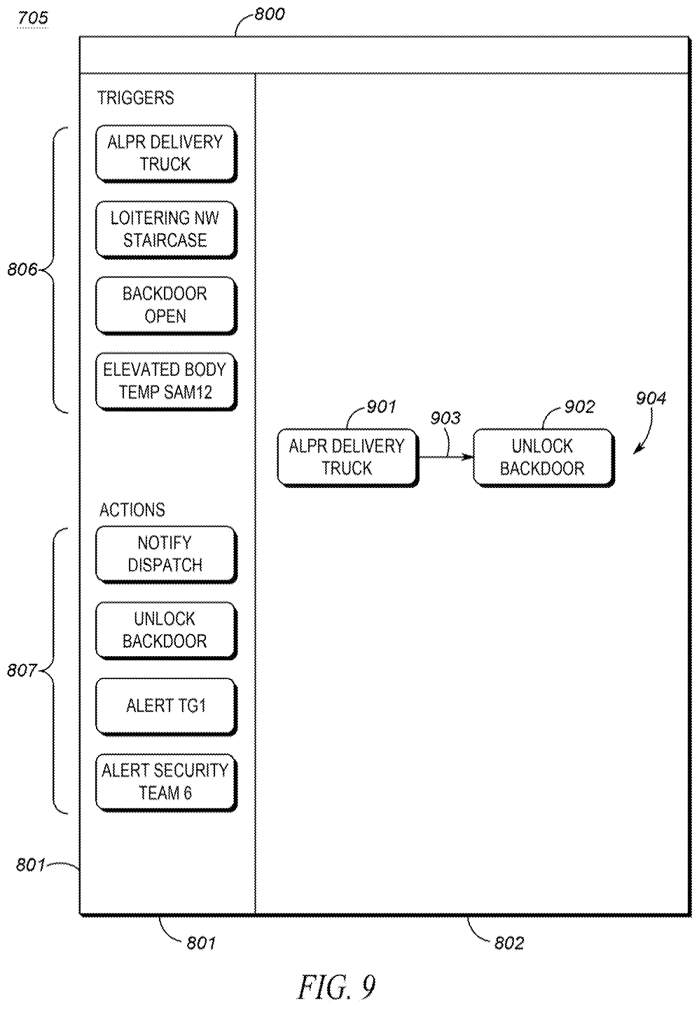

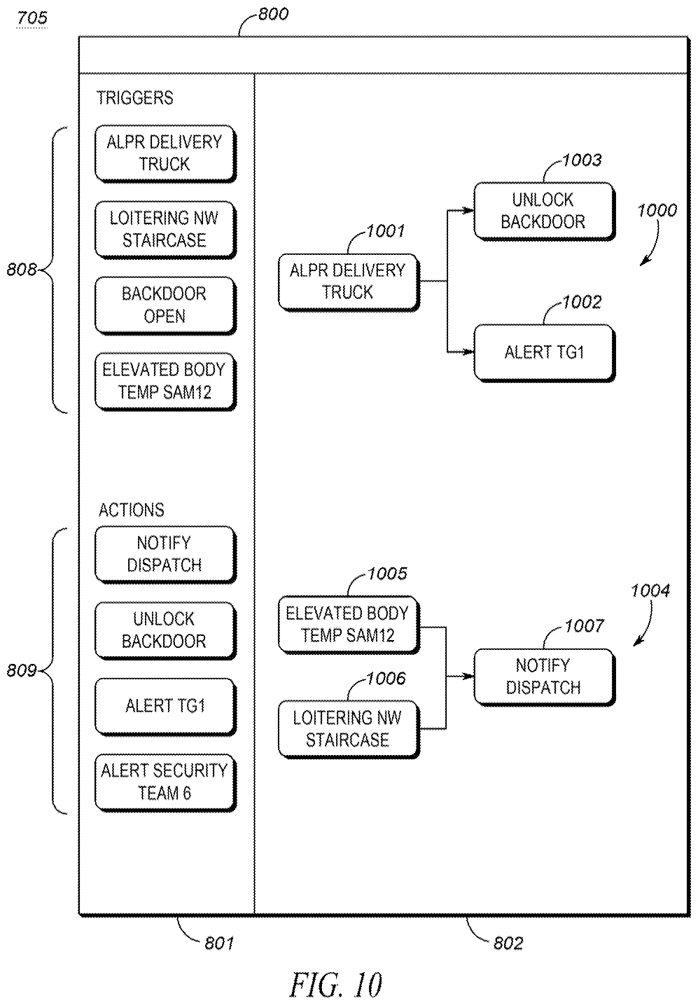

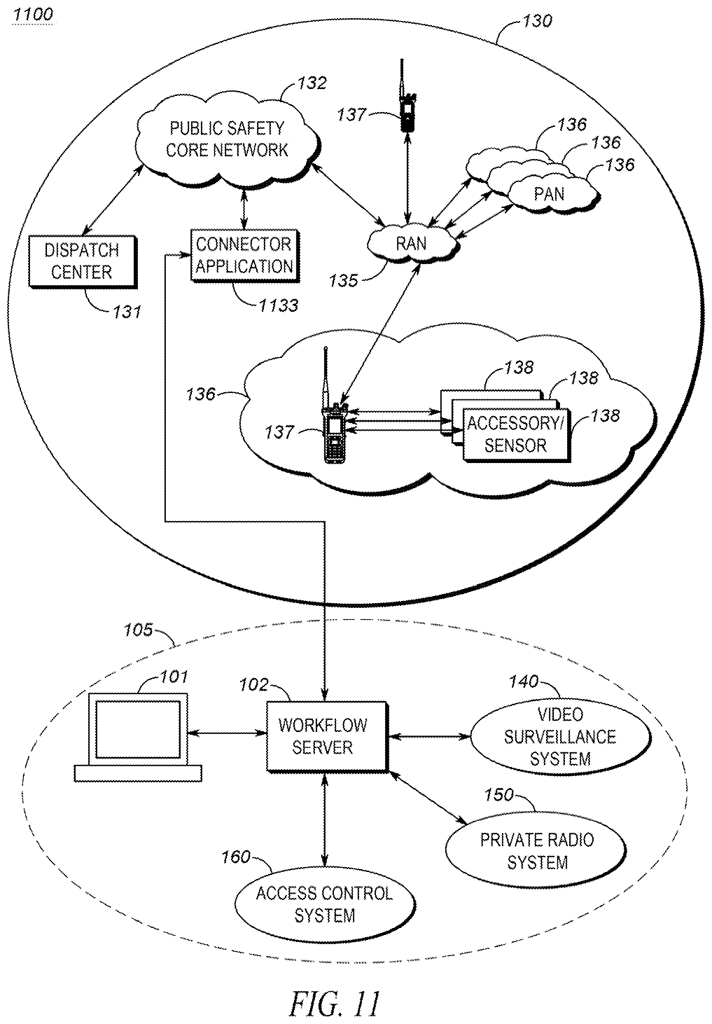

FIG. 3 illustrates a security ecosystem capable of configuring and automating workflows. In particular, FIG. 3 shows the security ecosystem 100 with an expanded view of the video surveillance system 140. As shown, the video surveillance system 140 comprises a plurality of image sensors and/or cameras 142 and the gateway 141.

Cameras 142 may be fixed or mobile, and may have pan/tilt/zoom (PTZ) capabilities to change their field of view. The cameras 142 are generally understood to comprise image sensors and hence may also be referred to as images sensors. Cameras 142 may also comprise circuitry configured to serve as a VAE 143 (only one of which is depicted in FIG. 3, though it is understood that any camera 142 may comprise circuitry configured to serve as a VAE 143). The VAE 143 comprises a software engine that analyzes analog and/or digital video. The engine configured to “watch” video and detect pre-selected objects such as license plates, people, faces, automobiles. The software engine may also be configured to detect certain actions of individuals, such as fighting, loitering, crimes being committed, . . . , etc. The VAE 143 may contain any of several object/action detectors. Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires.

The gateway 141 may comprise an Avigilon™ Control Center running Avigilon's Access Control Management software. The gateway 141 is configured to run any suitable Application Program Interface (API) to provide communications between any cameras 142 and the workflow server 102.

FIG. 4 illustrates a security ecosystem capable of configuring and automating workflows. In particular, FIG. 4 shows the security ecosystem 100 with an expanded view of the private radio system 150. As shown, the private radio system 150 comprises the gateway 151, system infrastructure 152, and at least one radio 153. Communications from the radio 153 to the workflow server 102 passes through the system infrastructure 152, the gateway 151, and ultimately to the workflow server 102.

The gateway 151 may comprise an Avigilon™ Control Center running Avigilon's Access Control Management software. The gateway 151 is configured to run any suitable Application Program Interface (API) to provide communications between any of the system infrastructure 152 and the workflow server 102.

The system infrastructure 152 comprises any suitable equipment to provide wireless communications to and from the radio 153. The system infrastructure 152 may comprise Motorola Solutions MOTOTRBO™ equipment, such as an SLR Series Repeater (e.g., SLR 1000, SLR 5000, or SLR8000 repeater) configured to provide two-way radio service to radio 153.

Although only a single radio 153 is shown in FIG. 4, any suitable number of radios 153 may be present within the private radio system 150. Each radio 153 may comprise a MOTOTRBO™ two-way radio (such as a Motorola Solution XPR 5000 Series radio) with digital technology providing integrated voice and data communication.

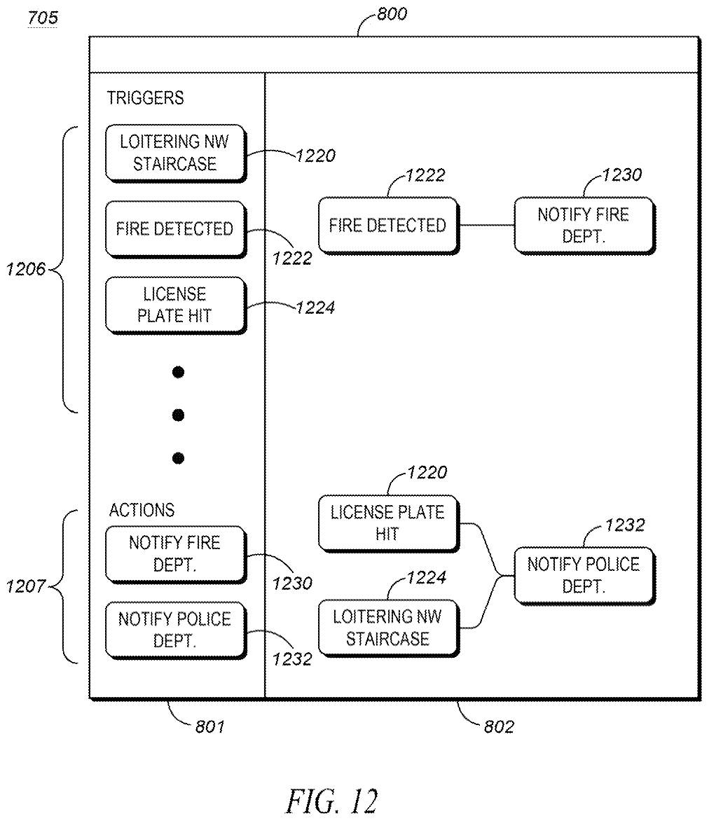

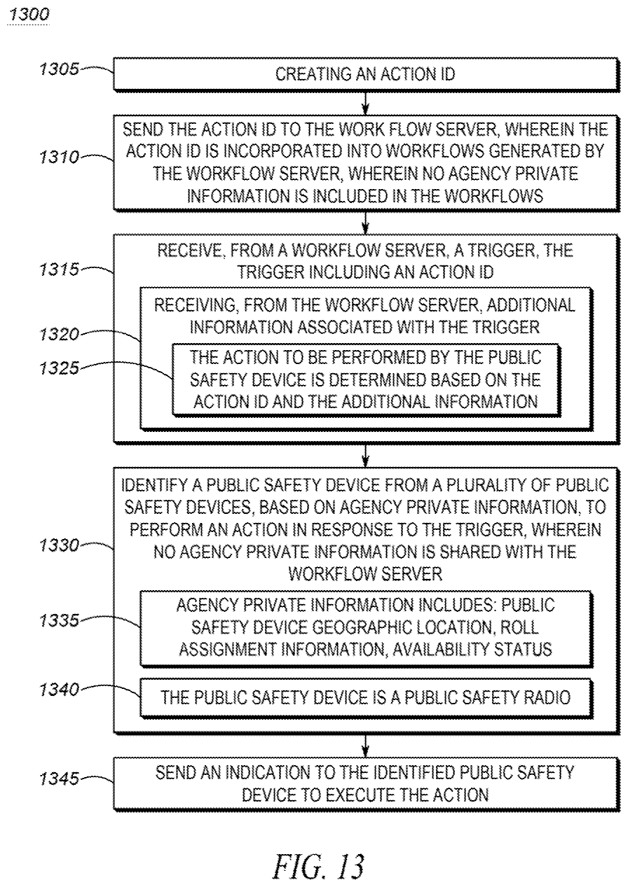

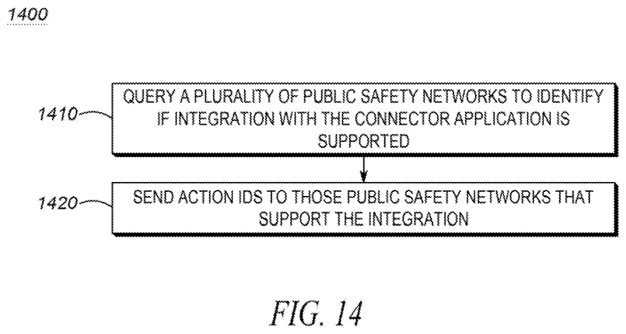

FIG. 5 illustrates a security ecosystem capable of configuring and automating workflows. In particular, FIG. 5 shows the security ecosystem 100 with an expanded view of the access control system 160. As shown, the access control system 160 comprises a gateway 162 and a plurality of IoT devices 163 coupled to the gateway 162. Data passed from the workflow server 102 to the IoT devices 163 passes through the network 161, the gateway 162 and ultimately to the IoT device 163. Conversely, data passed from the IoT devices 163 to the workflow server 102 passes through the gateway 162, the network 161, and ultimately to the workflow server 102.

The IoT devices 163 may comprise devices that control objects, doors, windows, sensors, and the like. Any particular suitable communication protocol (e.g. an IoT protocol) may be used for each IoT device. For example, various proprietary protocols such as DNP, Various IEC**** protocols (IEC 61850 etc.,), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 162 may comprise an Avigilon™ Control Center running Avigilon's Access Control Management software. The gateway 162 is configured to run any suitable Application Program Interface (API) to provide communications between any IoT device 163 and the workflow server 102.

The network 161 may comprise one of many networks used to transmit data, including, but not limited to, a network employing one of the following protocols: conventional, or trunked LMR standard or protocol such as ETSIDMR, a 25 standard defined by the APCO, TETRA, or other LMR radio protocols or standards; LTE protocol, LTE-Advance protocol, or 5G protocol including multimedia broadcast MBMS or SC-PTM protocol (including, but not limited to an OMA-PTT OMA-PoC), a VoIP protocol, an LTE Direct or LTE Device to Device protocol, or a PoIP protocol, a Wi-Fi protocol for example operating in accordance with an IEEE 802.11 standard (e.g., 802.11a, 802.11b, 802.11g) or a WiMAX protocol for example operating in accordance with an IEEE 802.16 standard.

FIG. 6 is a block diagram of the workflow server 102 of FIG. 1. As shown, the workflow server 102 comprises a network interface 601, a storage component 602 (e.g. as depicted a database, but may comprise any suitable memory and/or storage component), and a processor 603. The processor 603 is understood to include any suitable logic circuitry.

The network interface 601 includes any suitable components for communicating with other suitable components of the system 100, in particular, as depicted, to the workstation 101, the gateways 133, 141, 151, 162 of the networks and systems 130, 140, 150, 160, and the like. Components of the network interface 601 include any suitable processing, modulating, and transceiver components that are operable in accordance with any one or more standard or proprietary wireless interfaces, wherein some of the functionality of the processing, modulating, and transceiver components may be performed by means of the processor 603 through programmed logic such as software applications or firmware stored on the storage component 602 (e.g., standard random access memory) or through hardware. The network interface 601 may include any suitable wired or wireless network interfaces, including, but not limited to, Ethernet interfaces, T1 interfaces, USB interfaces, IEEE 802.11b interfaces, IEEE 802.11g interfaces, and the like.

The processor 603 may comprise a digital signal processor (DSP), general purpose microprocessor, a programmable logic device, or application specific integrated circuit (ASIC), and the like, and is generally configured to receive triggers from various gateways, systems, and networks (e.g. of the system 100). The processor 603 is further configured to execute (or cause to be executed) a particular action for a trigger that is received. More particularly, when the processor 603 receives a trigger from any network or system, the processor 603 may access the storage component 602 to determine an action for the particular trigger. Once an action has been determined, the processor 603 will execute the action, or cause the action to be executed. In order to perform the above, the processor 603 may executes an instruction set/software (e.g., Motorola Solution's Command Central™ software suite comprising the Orchestrate™ platform) which may be stored at the storage component 602.

The storage component 602 may comprises standard memory (such as Random Access Memory (RAM), Read Only Memory (ROM), and the like) and serves to store associations between triggers and actions. Examples of various triggers and actions are illustrated in in Table 1, below.

TABLE 1
Associations Between Triggers and Actions.

| Trigger | Action |
|---|---|
| Warehouse back door opened | Pan camera “342” to point at door |
| Man-Down sensor activated for | Notify dispatch center via emergency |
| Officer Smith | text message |
| ALPR for delivery truck | Open back gate |
| . . . etc. | . . . etc. |

FIG. 7 is a block diagram of the workstation 101 of FIG. 1 utilized to create a workflow. As shown, the workstation 101 comprises a network interface 701, a storage component 702, a processor 703, and a graphical user interface (GUI) 704.

The network interface 701 includes any suitable components for communicating with other suitable components of the system 100, in particular, as depicted, to the workflow server 102. Components of the network interface 701 include any suitable processing, modulating, and transceiver components that are operable in accordance with any one or more standard or proprietary wireless interfaces, wherein some of the functionality of the processing, modulating, and transceiver components may be performed by means of the processor 703 through programmed logic such as software applications or firmware stored on the storage component 702 (e.g., standard random access memory) or through hardware. The network interface 701 may include any suitable wired or wireless network interfaces, including, but not limited to, Ethernet interfaces, T1 interfaces, USB interfaces, IEEE 802.11b interfaces, IEEE 802.11g interfaces, and the like.

Processor 703 may comprise a DSP), general purpose microprocessor, a programmable logic device, or an ASIC and may be configured to execute Motorola Solution's Orchestrate™ and Ally™ dispatch and incident management software which may be stored at the storage component 702. The execution of such software may allow users of the GUI 704 to create workflows (i.e., actions and their associated responses) by receiving user inputs at the GUI 704 that define various triggers and their associated actions, which will ultimately be uploaded to the workflow server 102 and stored in the storage component 602.

The storage component 702 may comprise standard memory (such as RAM, ROM, and the like) and serves to store instructions as software. Particularly, Motorola Solution's Orchestrate™ and Ally™ dispatch and incident management software is may be stored at the storage component 702.

The GUI 704 generally provides a man/machine interface for receiving an input from a user and displaying information. For example, the GUI 704 may provide a mechanism of conveying (e.g., displaying) user-created workflows. Thus, the GUI 704 may also provide a mechanism for a user to input workflows into a displayed form. In order to provide the above features (and additional features), the GUI 704 may include any combination of a display screen 705 (e.g., a computer screen, which may include a touch screen, a monitor, and the like) and any suitable combination of one or more input devices 706 (e.g. a keyboard and mouse combination).

FIG. 8 illustrates the creation of a workflow. More particularly, FIG. 8 illustrates a dashboard 800 rendered at the display screen 705 utilized for the creation of workflows. As depicted, the dashboard 800 consists of the following main components:
a selection panel 801 (e.g. on a left-hand side), which lists available triggers 806 and actions 807;
a workspace 802, which comprises a large area in the middle of the dashboard 800 used to create workflows that define the connections between triggers and actions. Each workflow in the workspace is displayed as a separate field 808, 809 with an outline and a title. As shown in FIG. 8, two fields 808, 809 are shown, one labeled “trigger” and another labeled “action”.

While the dashboard 800 is depicted in a particular configuration, the dashboard 800 may have any suitable configuration; for example, the selection panel 801 may be on a right-hand side, a top side or a bottom side relative to the workspace 802.

The triggers 806 represent the events originating from various sensors, software, and devices within the security ecosystem 100. The actions 807 represent the possible responses to the triggers that may be implemented via any suitable various sensors, software, and devices within the security ecosystem 100, including, but not limited to, the radios 137, 153.

After a workflow is deployed (i.e., uploaded to the workflow server 102), its actions activate when the triggers occur. Triggers and actions appear on the workspace after they are dragged and dropped from the triggers 806 and actions 807 tabs respectively. For example, as depicted, the field 808 represents a trigger 806 that may have been dragged and dropped to the workspace 802 and the field 809 represents an action 807 that may have been dragged and dropped to the workspace 802. Connecting the triggers and actions on the workspace (as described below) will create a workflow.

The triggers 806 and the actions 807 are generally stored at the storage component 702 and represent integrations across multiple products. In other words, triggers 806 and the actions 807 comprise triggers and actions for any suitable components available in the security ecosystem 100. This includes cameras, sensors, IoT devices, radios, . . . , etc. As administrators add additional technology pieces to the security ecosystem 100, those pieces may be automatically made available for workflow creation as discussed herein.

In order to associate a trigger 806 with an action 807 in the workspace 802, a user selects a trigger 806 from all possible triggers 806, and drags and drops it onto workspace 802, as represented by the field 808. The user then selects an action 807 for the trigger 806 that is in the workspace 802, and drags and drops it onto workspace 802. Once in the workspace 802, a trigger 806 may be referred to as an trigger node, and an action 807 may be referred to as an action node. In order to associate the trigger 806 with the action 807, they are connected. To connect a trigger node to an action node, a user may click an end of the trigger node (e.g. that is closest to the action node) and drag a line to the action node, or vice versa. However, any suitable process for connecting nodes is within the scope of the present specification.

As shown in FIG. 9, which depicts the dashboard 800 in use, a trigger “ALPR delivery truck” 901 has been associated with an action “unlock back door” 902 by dragging a line 903 between the two, thereby forming a workflow 904. While only one trigger 901 and one action 902 is depicted in the workflow 904, the workflow 904 may comprise any suitable number of triggers (e.g. a trigger group) and any suitable numbers of associated action (e.g. an action group). Hence, if any of the triggers within a trigger group occurs, the workflow 904 is initiated causing the action to be executed. For example, as depicted ALPR stands for automated license plate reader, which may be one of the IoT devices 163; as such, according to the workflow 904, when automated license plate reader of the access control system 160 “reads” a license plate of a delivery truck (e.g. the trigger 901), an associated backdoor (e.g. of a warehouse) is opened; such a backdoor may also comprise one of the IoT devices 163. While note depicted, a memory in the system 100 may also store a list of license plates for which the backdoor is to be opened and the trigger 901 may include comparing a number of the license plate that is read with license plates in such a list, such that the backdoor is opened only when the license plate is on the list.

Furthermore, it is understood that the system 100 may comprise a plurality of IoT devices 163 that are automated license plate reader, and that the trigger 901 may be for a particular automated license plate reader; as such, while not depicted, the actions 807 may include respective “ALPR” actions 807 for other automated license plate reader. Similarly, it is understood that the system 100 may comprise a plurality of IoT devices 163 that are backdoors, and that the action 902 may be for a particular backdoor; as such, while not depicted, the actions 807 may include respective “Unlock Backdoor” actions 807 for other backdoors.

For example, as depicted the triggers 806 include a trigger 806 for detecting loitering at a particular “North West” (e.g. NW) staircase of a particular building (e.g. “Loitering NW Staircase”) that may be detected using a VAE 143 of one or more cameras 142 and the like. The triggers 806 further includes a trigger 806 for detecting whether a particular backdoor is open (e.g. “Backdoor Open”) that may be detected using a VAE 143 of one or more cameras 142 and/or an open/closed sensor on the backdoor and the like. The triggers 806 further includes a trigger 806 for detecting whether a particular individual, for example a first responder and/or police officer and/or security guard having an identifier “SAM12” has an elevated body temperature (e.g. “Elevated Body Temp SAM12”) that may be detected using a biometric sensor of one or more sensors 138 and the like.

For example, as depicted the actions 807 include an action 807 for notifying a first responder and/or police and/or security dispatch (e.g. “Notify Dispatch”) such as the dispatch center 131. The actions 807 further includes an action 807 for alerting a particular talkgroup identified by the identifier TG1 and/or Talkgroup #1 (e.g. “Alert TG1”) such as a particular talkgroup of the radios 137 (and/or the radios 153). The actions 807 further includes an action 807 for alerting a particular security team identified by the identifier Security Team 6 (e.g. “Alert Security Team 6”) which may be associated with a particular group of the radios 137 (and/or the radios 153) and which may, or may not, be associated via a talkgroup.

However, the triggers 806 and actions 807 may include any suitable triggers and actions, which may be dragged and dropped, and the like, into the workspace 802, and associated with each other to generate workflows.

As illustrated in FIG. 10, a single trigger may be associated with multiple actions in a workflow. Thus, in an illustrated workflow 1000, a trigger 1001 of “ALPR delivery truck” may be associated with an action 1003 of “Unlock Back Door” 1003 as well as associated with an action 1002 of “Alert TG 1”. When the workflow 1000 is uploaded to the workflow server 102, and the automatic license plate detects a delivery truck, workflow server 102 will cause both the back door to unlock and an alert to be sent on Talkgroup #1.

In a similar manner multiple triggers may be associated with a single action. Thus, in an illustrated workflow 1004, both a trigger 1005 of “Elevated Body Temp SAM 12” and a trigger 1006 of “Loitering NW Staircase” will cause an action 1007 of “Notify Dispatch” 1008. When the workflow 1004 is uploaded to the workflow server 102, the workflow server 102 notifies the dispatch center when either a police officer (and the like) identified by the identifier “SAM 12” has an elevated body temperature (e.g. above a threshold body temperature”, or when loitering is detected in the NW staircase.

As mentioned above, a problem arises in a system implemented as above when dealing with systems that are not under the control of the enterprise. As explained above with respect to FIG. 2, information flows freely between the public safety network 130 and the workflow server 102. Although the flow of information from the workflow server to the public safety network is generally not a problem, the flow of information in the other direction is not desirable. The public safety network may have agency private information (e.g. current staffing levels, availability levels, incidents in progress, response times, officer locations, etc.) that for various reasons should not be shared with the enterprise implementing the workflow server.

In order to address the techniques described herein provide an abstraction layer in the form of a connector application between the workflow server and the public safety network. The connector application is implemented by the public safety network and is implemented in a trusted environment, either using on premise equipment or in the cloud. Regardless of where implemented, it should be understood that the connector application is trusted by the public safety network.

The connector application provides one or more actions to the workflow server. Each of these actions may include an action ID. The action ID may indicate the type of action that is being requested from the public safety network, but does not specifically include what actions are to be performed by the public safety network. These action IDs may then be used by the workflow server when creating workflows. For example, the action could be included in the list of possible actions 807 that are available to be dragged and dropped into the workspace 802.

FIG. 11 is an example of a communications system 1100 that may implement the connector application to cause an action to be executed by a public safety device techniques described herein. The communications system described in FIG. 11 is essentially the same as that described with respect to FIG. 2 with the exception that the gateway 133 has been replaced with a connector application 1133. Although the connector application has been depicted as being included within public safety network 130, it should be understood that the actual implementation could occur in the public safety network, in the cloud, or in any other environment trusted by the public safety network. Example devices that could be used to implement the connector application are described with respect to FIGS. 6 and 7.

As shown, the communication system 1100 includes a workflow server 102 operating within a commercial enterprise 105. All elements within the commercial enterprise, which can also be referred to as the enterprise, are generally under the control of the enterprise. This means that information can freely be shared between the entities, such as the video surveillance system 140, the private radio system 150, and the access control system 160.

The communications system may also include one or more public safety networks 130. The public safety networks describe with respect to FIG. 11 are generally the same as those described with respect to FIG. 2, with the exception that the gateway is replaced by the connector application 1133 which serves to isolate the workflow server 102 from the public safety network.

In operation, a workflow server 102 may operate within a commercial enterprise as described above. The workflow server may be configured by an operator with workflows. The workflows may be created by providing the operator a selection of possible actions and triggers. The operator 806, 807. The operator may drag and drop those actions and triggers into a workspace 802 and connect the actions and triggers. When the workflow server detects a trigger, the corresponding action within the workflow may be executed.

The communication system 1100 also includes a private radio system operated by the enterprise. The private radio system is operatively coupled through a wireless connection to the workflow server and the workflow server executes workflows to manage at least one radio in response to predetermined triggers received by the workflow server. In other words, there may be workflows, that when initiated by a trigger, cause the workflow server to perform an action that includes at least one of the radios in the private radio system 150. For example, the action could be to cause a message to be sent to the private radio requesting the operator of the radio to take some action.

The communication system 1100 also includes a public safety device, which can include a public safety radio 137, operatively coupled through a wireless connection to a public safety radio access network 135 that operates within a public safety core network 132.

In response to receiving the predetermined trigger, the workflow server 102 may be configured to send a notification to a connector application 1133 operatively coupled to the public safety core network 132 to execute a public safety action, the notification containing an action ID. As will be explained in further detail below, the workflow server does not directly interface with the public safety network. Instead, the connector application 1133 provides actions that include action IDs. When a trigger occurs that initiates a workflow that includes one of these action IDs, the action ID is sent when sending the notification to the connector application.

The connector application 1133 is further configured to connect to the public safety core network 132 and create public safety action IDs based on agency specific information. For example, the connector application may create an action ID related to a workflow where some trigger has occurred (e.g. loitering). The connector application may send this action ID to the workflow server with an indication that whenever a loitering trigger is detected this action ID may be used to request action from public safety. What should be understood is that the action ID is used to report the trigger to the connector application, but in and of itself causes no action to be taken by the public safety network.

The created public safety action IDs are based on agency specific information. For example, the action IDs could be based on current availability of officers, current locations, current assignments, priority of those assignments, etc. What should be understood is that the agency information that is used to create the action IDs is never shared with the workflow server.

The connector application is further configured to add the created public safety action IDs to the workflow server. The public safety action IDS can be added to the workflow server 102 as actions 807 that can be dragged into the workspace and associated with triggers 806.

The connector application 1133 is further configured to receive the notification and execute the public safety action based on the public safety action ID, independently of the workflow server 102. In other words, unlike the action execution described above in which the workflow server initiates the action (e.g. within the private radio system 150, etc.) in this case, the workflow server simply send the public safety action ID to the connector application. From there, the connector application determines what actions are to be taken. The workflow server is not involved in deciding what actions are taken and may not even be informed of what actions were taken in the public safety network 130.

In some cases, the workflow server 102 executes the workflow by sending a list of action IDs from the workflow server to the connector application, wherein control of the execution resides in the connector application 1133. In some cases, a trigger may cause multiple actions with action IDs to be executed. A list of all these action IDs is sent to the connector application. Control of the execution resides in the connector application.

The public safety radio 137 may be one of a plurality of public safety radios operating in accordance with agency specific functions of the public safety agency. For example, different radios may be assigned to different roles within the public safety agency (e.g. police, fire, EMS, etc.). The workflow server 102 need have no knowledge of this relationship. The agency may pre-provision the public safety radio 137 to accept workflow management from the connector application based on workflows defined in the workflow server. In other words, the public safety radio may be configured to be directly controlled by the connector application, just as if it were being controlled by the workflow server. This may involve installing an application on the public safety radio in order to be able to receive commands from the connector application. What should again be noted is that agency specific information associated with the connector application is isolated from the workflow server.

The triggers may be generated by any source connected to the workflow server. For example, triggers could include at least one of a security camera, a fire detector, and an automated license plate reader. Any of the other triggers described above could also be utilized. What should be understood is that any input capable of being received by the workflow server can be converted into t trigger. Those triggers can then be associated with actions to form workflows.

FIG. 12 illustrates the creation of a workflow using actions provided by a connector application according to the techniques described herein. FIG. 12 includes a similar environment to that described with respect to FIGS. 8-10. FIG. 12 includes triggers 1206 from selection panel 801 that may be dragged into the workspace 802 in order to create workflows. As explained previously, triggers are what causes a workflow to be initiated.

In the present example, three example triggers are shown. It should be understood that this is for ease of description rather than by way of limitation. An actual workflow server could include any number of possible triggers. The first trigger is for loitering in the NW staircase 1220. This trigger was previously described and may occur when a video surveillance system detects that there is a person loitering in the staircase.

The next trigger is fire detected 1222. The fire detected trigger could occur when any sensor connected to the workflow server has detected a fire. For example, the video surveillance system 140 may be used to detect fires. As yet another example, IoT devices 163 may include sensors capable of detecting fire. The specific techniques used to detect a fire are relatively unimportant, so long as the workflow server is made aware a fire has been detected.

The third trigger shown is a license plate hit 1224 trigger. This trigger may occur when an automated license plate reader has detected a license plate of interest. For example, the license plate could be that of a vehicle reported stolen or involved in an some other type of alert (e.g. amber alert, silver alert, etc.).

FIG. 12 also includes actions 1207. In this particular example, the actions that are performed by the workflow server and systems under control of the workflow server are omitted. In this example, two actions are depicted. These actions are provided by the connector application itself.

The first action is the notify fire department action 1230. The connector application 1333 may provide a workflow server 102 an action with the action ID of Notify Fire Department. The workflow server need not have any information regarding how to notify the fire department. The workflow server will have no information from the public safety agency as to the resources that will be used to respond when this particular action is triggered. The workflow server will have no control over the operation of the public safety network when this application is triggered.

The second action is the notify police department action 1232. Just as with the notify fire department action, the connector application 1133 simply provides an action with an action ID indicating that the police department should be notified. The particular details of the police department resources being used to carry out the action is not revealed to the workflow server 102. Likewise, the workflow server will have no control and will not directly interact with any resources of the public safety network.

Creation of workflows proceeds just as it did with the previous examples. If the user wishes to create a workflow for when the fire detected trigger 1222 is received by the workflow server 102, the user can simply drag that trigger from the selection panel 801 onto the workspace 802. The user may then drag an action onto the workspace and make a connection between the two. In this example, the notify fire department action 1230 may be placed in the workspace and connected to the fire detected trigger.

When the fire detected trigger occurs 1222, the workflow server 102 initiates the workflow associated with the notify fire department action 1230. As described above, the connector application 1133 provided the action to the workflow server with an action ID. The workflow server may then send the action ID, as well as any information associated with the trigger, to the connector application via a notification. In this example, information associated with the fire detected trigger could include location of the fire, intensity of the fire, size of the fire, hazardous materials associated with the fire, etc.

Upon receipt of the notification, the connector application 1133 may examine the notification to identify the action ID. In this case, the action ID is to notify the fire department. The connector application may also look at the trigger information to determine exactly which resources will be needed to address the trigger. Because the connector application is trusted by the public safety networks, the connector application is able to have access to agency private information need to determine the proper response. For example, this information can include which fire trucks are available, how many fire trucks are needed, which ones are properly equipped for this type of fire, etc. The connector application may then interact with the public safety network 130, in particular the dispatch center 131 to cause the appropriate responders to be notified via their public safety radios 137 or other public safety devices.

What should be understood is that there was no direct communication or control of the public safety network from the workflow server. Furthermore, there was no agency private data (e.g. available units, etc.) that was made available to the workflow server 102 in order for it to execute the action. The workflow server simply executed an action including an action ID provided by the connector application 1133 and the connector application handled all of the actions that required use of agency private data.

In the previous example workflow, there was a one to one correspondence between the trigger and the action ID. However, the techniques described herein are not so limited. As shown, there may be two triggers, the license plate hit trigger 1220 and the loitering in the hallway trigger 1224 that both require that the police department be notified 1232. In some implementations, the connector application 1133 may provide a limited number of action IDs for interaction with a public safety agency.

In this particular example, any action needed from the police department may be associated with the notify police department action 1232, regardless of the trigger. When the notification is sent to the connector application 1133, the trigger information may be sent as well. Using the action ID and the information included in the trigger, the connector application may determine what actions with the public safety network 130 are required.

For example, the trigger could include a license plate number for a license plate hit 1220 and this information could be passed to the connector application 1133. The connector application uses this information to determine that the specific trigger is a license plate hit and responds accordingly. For example, the connector application may identify responders currently on duty and available, who are near the vicinity of where the license plate hit occurred, and are assigned to vehicle based incidents, by accessing the dispatch center. This information could then be used to send a message to the radio associated with the identified responders. Again, it should be clear that none of the agency private information was shared with the workflow server.

Similarly, the loitering trigger 1224 could cause the same action ID, notify police department 1232 to occur. This action ID, along with trigger information, could be sent to the connector application 1133. The connector application may utilize the information in the trigger contained in the notification of the action ID to determine that the trigger was based on loitering. The connector application may then use agency private data (e.g. available responders, location of responders, etc.) to identify appropriate responders. Those responders may then be notified via their radios. Once again, no agency private information was shared with the connector application.

Although having a single action ID for an agency as described above is possible, the techniques described herein are not so limited. For example, for each trigger, there could be a separate action ID assigned. For example, there could be separate action IDs for notifying police of loitering and notifying police of license plate hit. Including individual action IDs may make it easier to implement the connector application as it will not need to determine the specific action that is being requested, as it is included in the action ID sent from the workflow server. However, this may make setting up workflows a bit more difficult, as a more specific action ID would need to be selected depending on the specific workflow trigger.

It is also possible to take a hybrid approach, wherein there are a limited number of action IDs that are used with a larger number of triggers. For example, there could be a notify police department-urgent action ID and a notify police department-non-urgent action ID. For any triggers requiring an urgent response, the first action ID can be selected. For those that do not require an urgent response, the second action ID could be selected.

FIG. 13 is an example flow chart 1300 describing an implementation of a connector application according to techniques described herein. In block 1305, an action ID is created. This block may occur while the communications system described with respect to FIG. 11 is being configured. As explained previously, the connector application may create action IDs which are then used by the workflow server to cause a public safety network to execute an action, without requiring private information to be shared with the workflow server. Some examples of action IDs, such as notify police department and notify fire department were described above. What should be understood is that an action ID will be associated with a notification sent to the connector application to identify the action that the workflow server is requesting the public safety network to perform.

In block 1310 the action ID is sent to the workflow server, wherein the action ID is incorporated into workflows generated by the workflow server, wherein no agency private information is included in the workflows. The action IDs are distributed to the workflow server, which in turn can then include the action ID within an action selection panel of a workspace, as described above with respect to FIG. 12. The workflow server user may then use these action IDs by dragging them into the workspace and associating them with triggers in order to create workflows.

In block 1315, a trigger may be received from the workflow server, the trigger including an action ID. The trigger can also be referred to as a notification being received from the workflow server. The notification may include information related to the trigger (e.g. type of incident, location of incident, etc.).

In block 1320, additional information associated with the trigger may be received from the workflow server. This information may be used by the connector application to determine which action to perform. In block 1325, the action to be performed by the public safety device is determined based on the action ID and the additional information.

As explained above, in some cases, the action ID may be associated with a more general action (e.g. notify police department, etc.). It is then left to the connector application to determine the specific actions that are needed to respond to the request. For example, if the additional information for the notify police department trigger indicates the trigger was from a person loitering, a radio associated with an officer on patrol in the area of the loitering is notified. If the additional information indicated a license plate hit occurred, a radio associated with an officer assigned to a vehicle detail is notified.

In block 1330, a public safety device from a plurality of public safety devices is identified, based on agency private information, to perform an action in response to the trigger, wherein no agency private information is shared with the workflow server. For example, the connector application may select a public safety device to respond to the trigger. The selection of the public safety device may be based on private information that the agency does not wish to share with the workflow server.

In block 1335, some examples of such private information can include geographic location of responders, roll assignment of responders, and availability status of responders. There are many types of tactical and/or strategic information regarding current capabilities and/or configuration of a public safety network that would be undesirable to share with the workflow server, which generally belongs to a private enterprise. Using the techniques described herein, this private information is not shared with the workflow server.

In block 1340, the public safety device is a public safety radio. Throughout most of the examples presented herein, a notification is sent to an officers public safety radio. However, this was for ease of description rather than by way of limitation. Although a public safety radio is one possible type of device, other devices could include pagers, tablets, computer terminals, augmented realty glasses, etc. What should be understood is that the techniques described herein are not limited to radios, even though that is a very likely use case.

In block 1345, an indication is sent to the identified public safety device to execute the action. Once a device has been identified to execute the action ID triggered by the workflow server, the request to perform the action is sent to the identified device. In some implementations, a user currently associated with the identified device can then carry out the action necessary to respond to that type of trigger. Again, it should be noted that none of the agency private information that was used to identify the device is ever sent to the workflow server and at all times remains under the control of systems trusted by the public safety networks.

FIG. 14 is an example of a flowchart 400 for supporting multiple public safety networks with one connector application. Although the previous description has been in terms of a single workflow server interacting with a single connector application which in turn interacts with a single public safety network, the techniques described herein are not so limited. The connector application 1133 may interface with many different public safety networks as well as many different workflow servers. The connector application may be thought of as a shared resource usable by many different public safety networks and workflow servers at the same time.

In block 1410, a plurality of public safety networks is queried to identify if integration with the connector application is supported. Support for integration with the connector application means that the public safety network is configured to operate with the connector application as described above. This block is in essence a discovery process to determine if the public safety network may utilize the techniques described herein.

In block 1420, action IDs are sent to those public safety networks that support the integration. The action IDs may have been generated with respect to FIG. 13. In other words, the action IDs are used to let the public safety networks know the types of actions the connection application will be requesting that the public safety network will perform.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, implement electronic workflows, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium (e.g. non-transitory) having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication system, comprising:
a workflow server operating within a commercial enterprise;
a private radio system comprising at least one radio operatively coupled through a wireless connection to the workflow server, the workflow server executing workflows to manage the at least one radio in response to predetermined triggers received by the workflow server;
a public safety radio operatively coupled through a wireless connection to a public safety Radio Access Network operating within a Public Safety Core Network; and
the workflow server in response to receiving the predetermined trigger, being configured to:
send a notification to a connector application operatively coupled to the Public Safety Core Network to execute a public safety action, the notification containing a public safety action ID.

2. The communication system of claim 1, wherein the connector application is configured to:
connect to the public safety core network and create the public safety action ID based on agency specific information; and
add the created public safety action ID to the workflow server.

3. The communication system of claim 1, wherein the connector application is configured to:
receive the notification and execute the public safety action based on the public safety action ID, independently of the workflow server.

4. The communication system of claim 1, wherein the workflow server executes the workflow by:
sending a list of action IDs from the workflow server to the connector application, wherein control of the execution resides in the connector application.

5. The communication system of claim 1, wherein the public safety radio is one of a plurality of public safety radios operating in accordance with agency specific functions of a Public Safety agency.

6. The communication system of claim 5, wherein an agency pre-provisions the public safety radio to accept workflow management from the connector application based on workflows defined in the workflow server.

7. The communication system of claim 6, wherein agency specific information associated with the connector application is isolated from the workflow server.

8. The communication system of claim 1, wherein the trigger is generated by at least one of a security camera, a fire detector, and an automated license plate reader.

9. A method performed by a connector application comprising:
receiving, from a workflow server, a trigger, the trigger including an action ID;
identifying a public safety device from a plurality of public safety devices, based on agency private information, to perform an action in response to the trigger, wherein no agency private information is shared with the workflow server;
sending an indication to the identified public safety device to execute the action.

10. The method of claim 9 further comprising:
creating an action ID;
sending the action ID to the workflow server, wherein the action ID is incorporated into workflows generated by the workflow server, wherein no agency private information is included in the workflows.

11. The method of claim 9 further comprising:
receiving, from the workflow server, additional information associated with the trigger;
wherein the action to be performed by the public safety device is determined based on the action ID and the additional information.

12. The method of claim 9 wherein agency private information includes public safety device geographic location.

13. The method of claim 9 wherein agency private information includes public safety device roll assignment information.

14. The method of claim 9 wherein agency private information includes public safety device availability status.

15. The method of claim 9 further comprising:
querying a plurality of public safety networks to identify if integration with the connector application is supported; and
sending action IDs to those public safety networks that support the integration.

16. The method of claim 9 wherein the public safety device is a public safety radio.

17. A non-transitory processor readable medium containing a set of instructions to implement a connector application thereon that when executed by a processor cause the processor to:
receive, from a workflow server, a trigger, the trigger including an action ID;
identify a public safety device from a plurality of public safety devices, based on agency private information, to perform an action in response to the trigger, wherein no agency private information is shared with the workflow server;
send an indication to the identified public safety device to execute the action.

18. The non-transitory medium of claim 17 further comprising instructions that cause the processor to:
create an action ID;
send the action ID to the workflow server, wherein the action ID is incorporated into workflows generated by the workflow server, wherein no agency private information is included in the workflows.

19. The non-transitory medium of claim 17 further comprising instructions that cause the processor to:
receive, from the workflow server, additional information associated with the trigger;
wherein the action to be performed by the public safety device is determined based on the action ID and the additional information.

20. The non-transitory medium of claim 17 further comprising instructions that cause the processor to:
query a plurality of public safety networks to identify if integration with the connector application is supported; and
send action IDs to those public safety networks that support the integration.
